(19) United States
(12) Patent Application Publication
(10) Pub. No.: US 2026/0285477 A1
(43) Pub. Date: Sep. 24, 2026

(54) Coordinated Retractable Landing and Structural System for Aerial Vehicles

(71) Applicant: Ryan Joseph Bohm, Logan, UT (US)

(72) Inventor: Ryan Joseph Bohm, Logan, UT (US)

(21) Appl. No.: 19/575,934

(22) Filed: Mar. 24, 2026

Related U.S. Application Data
(60) Provisional application No. 63/776,829, filed on Mar. 24, 2025.

(51) Int. Cl. B64C 25/28; B64C 39/02; B64D 45/00; B64U 60/40

(52) U.S. Cl. CPC B64C 25/28; B64C 39/026; B64D 45/00; B64U 60/40; B64D 2045/0085

(57) ABSTRACT

An aerial vehicle includes a retractable landing gear system configured to transition between a deployed landing configuration and a compact stowed configuration. The landing gear is operatively coupled with one or more secondary structures, including a passenger seat, control interface, or payload support structure, such that the landing gear and the secondary structures move in coordination during retraction and deployment. A control system permits retraction only when one or more safety conditions are satisfied, including absence of a passenger or payload. The control system further includes a fail-safe mode that prevents retraction upon detection of a fault condition. The retracted configuration reduces the overall spatial envelope of the aerial vehicle to facilitate transport, storage, or interaction with an external platform.

### CROSS-REFERENCE TO RELATED APPLICATIONS

This application claims the benefit of U.S. Provisional Application No. 63/776,829, filed Mar. 24, 2025, the entire contents of which are incorporated herein by reference.

### FIELD OF THE INVENTION

The present invention relates generally to aerial vehicles, including personal air vehicles (PAVs), unmanned aerial systems, and cargo transport drones, and more particularly to systems for coordinated reconfiguration of landing gear and associated structures to enable reduction of a spatial envelope of the aerial vehicle for storage, transport, or interaction with external platforms.

### BACKGROUND OF THE INVENTION

Aerial vehicles, including personal air vehicles (PAVs), unmanned aerial systems, and cargo transport drones, are increasingly being developed for transportation, logistics, and mission-based applications. As these systems evolve, there is a growing need for efficient methods of storing, transporting, and deploying such vehicles without requiring specialized infrastructure or excessive handling complexity.

Conventional aerial vehicles typically utilize fixed landing gear or structures that remain extended during all phases of operation. While suitable for flight and landing, such configurations increase the overall spatial envelope of the vehicle, which can complicate storage, transport, and integration with external platforms. In particular, increased height or footprint may limit compatibility with transport systems, including vehicle-mounted or space-constrained environments.

While retractable or foldable components have been proposed, existing approaches often treat landing gear, passenger interfaces, and payload structures as independent systems, resulting in increased mechanical complexity, added weight, and inefficient use of available space. Additionally, conventional systems may lack sufficient safeguards to prevent unintended reconfiguration when a passenger or payload is present, which can introduce safety concerns.

There remains a need for an aerial vehicle configuration that enables reduction of the overall spatial envelope through coordinated reconfiguration of multiple structures while maintaining simplicity, reliability, and safety. In particular, there is a need for systems that integrate landing gear retraction with other vehicle structures and that incorporate robust interlocks and fail-safe behavior to prevent unsafe operation.

### SUMMARY OF THE INVENTION

In one aspect, an aerial vehicle is provided with a retractable landing gear system configured to transition between a deployed configuration for landing and a stowed configuration for transport and storage. The landing gear is configured to retract into a region of the vehicle that is otherwise unused during flight, thereby reducing the overall vehicle envelope.

In another aspect, the landing gear is operatively coupled to one or more secondary structures, including but not limited to a passenger seat, control interface, or payload support structure, such that the landing gear and the secondary structures move in coordination during retraction and deployment. This coordinated motion enables multiple vehicle components to be compactly arranged without increasing structural complexity or spatial requirements.

In another aspect, a control system governs retraction of the landing gear based on one or more safety conditions. These conditions may include detection of passenger presence, payload presence, or other operational constraints. Retraction is inhibited when such conditions are present.

In another aspect, the system is configured to operate in a fail-safe manner such that, upon detection of a fault condition during a retraction sequence, the landing gear remains in or returns to the deployed configuration, thereby preserving landing capability and operational safety.

In another aspect, the compact stowed configuration facilitates interaction with external structures, including transport platforms, storage systems, or docking interfaces, while maintaining the aerial vehicle in a flight-capable condition.

### BRIEF DESCRIPTION OF THE DRAWINGS

FIG. 1 illustrates a representative aerial vehicle with the landing gear and associated structures in a stowed configuration.

FIG. 2 illustrates the aerial vehicle of FIG. 1 with the landing gear and associated structures in a deployed configuration.

### DETAILED DESCRIPTION OF THE INVENTION

The present invention relates to an aerial vehicle having a retractable landing gear system configured to reduce the spatial envelope of the vehicle during non-operational states such as transport, storage, or interaction with external platforms. The system further enables coordinated movement of additional structures within the vehicle to improve compactness while maintaining operational readiness and safety.

For purposes of this description, the term “aerial vehicle” includes, but is not limited to, personal air vehicles (PAVs), unmanned aerial systems, cargo transport drones, and mission-adaptable aircraft. The term “secondary structure” refers to any structure associated with the vehicle that is not required to remain in a fixed configuration during flight, including but not limited to passenger seating, control interfaces, payload support structures, or mission-specific modules.

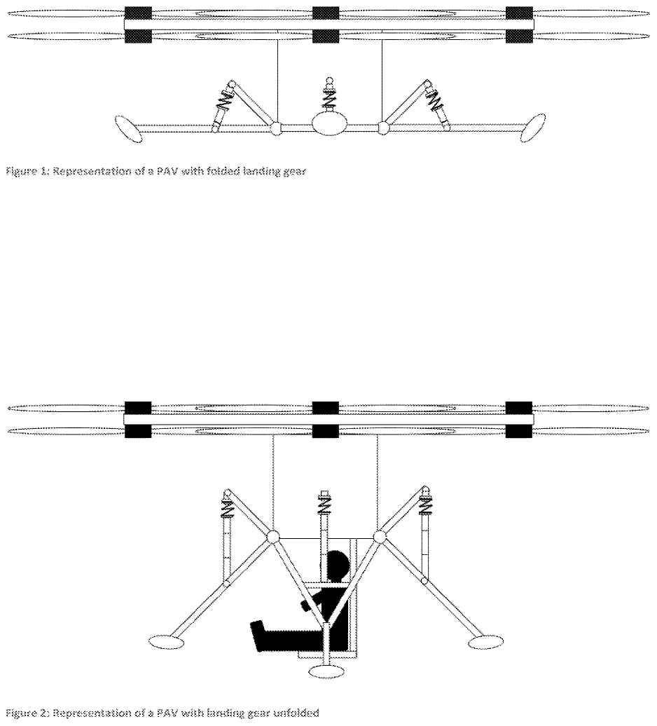

Referring now to FIG. 1, an example aerial vehicle is illustrated with the landing gear and associated secondary structures in a stowed configuration. In this configuration, the landing gear is retracted into an internal region of the aerial vehicle, and the secondary structure is positioned in a compact arrangement. As shown, coordinated positioning of the landing gear and the secondary structure reduces the overall spatial envelope of the aerial vehicle relative to a deployed configuration.

Referring now to FIG. 2, the aerial vehicle of FIG. 1 is illustrated with the landing gear and associated secondary structures in a deployed configuration. In this configuration, the landing gear extends downward to support the aerial vehicle during landing and ground operations, and the secondary structure is arranged for operational use. Transition between the configurations of FIGS. 1 and 2 is performed in a coordinated manner, as described herein, such that the landing gear and the secondary structure move in relation to one another during retraction and deployment.

In one embodiment, the aerial vehicle includes a primary flight assembly comprising propulsion elements such as motors and propellers supported by a structural frame. A lower region of the vehicle, positioned below the primary flight assembly, accommodates a retractable landing gear system. The landing gear includes one or more legs configured to extend downward to support the vehicle during landing and ground operations and to retract upward into a stowed configuration.

The landing gear is configured to transition between a deployed configuration and a stowed configuration. In the deployed configuration, the landing gear provides sufficient structural support and shock absorption to accommodate landing loads, including those associated with a passenger or payload. In the stowed configuration, the landing gear occupies a reduced volume within the vehicle, thereby reducing the overall height or spatial footprint of the aerial vehicle.

In one embodiment, the landing gear retracts into an internal region of the aerial vehicle located below the primary flight assembly and above a lower boundary of the aerial vehicle. This region may be defined, at least in part, by the arrangement of structural elements, energy storage systems such as battery packs, or other components that create a volume suitable for receiving the landing gear when retracted. By utilizing an otherwise unused or underutilized volume, the system minimizes the impact of the landing gear on the aerodynamic and structural design of the vehicle.

In another embodiment, the landing gear is operatively coupled to one or more secondary structures. The coupling may be mechanical, electromechanical, or implemented through coordinated control of separate actuators. The secondary structures may include a passenger seat, control panel, control input devices, cargo interface, or other mission-specific components.

The landing gear and the secondary structures are configured to move in coordination during transitions between configurations. For example, during a retraction sequence, the landing gear may move upward into a stowed position while the secondary structure simultaneously folds, collapses, or translates into a compact configuration. This coordinated movement allows multiple components to share space within the vehicle and reduces the overall envelope without requiring independent retraction mechanisms for each component. In some embodiments, this shared use of internal space reduces or eliminates the need for separate stowage volumes for the landing gear and the secondary structure.

In some embodiments, the coordinated movement is achieved through a shared actuator or a system of linked mechanical members such that actuation of the landing gear directly causes motion of the secondary structure. In other embodiments, separate actuators are controlled by a common control system to achieve synchronized motion. The coordinated system may be configured such that the secondary structure is not able to occupy its deployed configuration when the landing gear is stowed, thereby ensuring consistent system states.

A control system governs operation of the landing gear and associated structures. The control system may include one or more processors, control logic, and interfaces to sensors and actuators. The control system is configured to permit retraction of the landing gear only when predefined safety criteria are satisfied.

In one embodiment, the system includes one or more sensors configured to detect conditions associated with passenger presence or payload presence. These sensors may include, but are not limited to, seat pressure sensors, restraint or wrist-clip sensors, cargo weight sensors, or payload retention sensors. The control system evaluates the outputs of these sensors to determine whether a passenger or payload is present.

Retraction of the landing gear is inhibited when a passenger or payload is detected. In some embodiments, the control system requires confirmation from multiple independent sensors before permitting retraction, thereby reducing the likelihood of erroneous operation due to sensor failure or noise.

In addition to occupancy or load-based interlocks, the system may include mechanical interlocks configured to physically prevent retraction under certain conditions. Such interlocks may include pins, latches, or other securing mechanisms that must be disengaged prior to initiating a retraction sequence. These mechanical interlocks may operate independently of, or in conjunction with, electronic control logic.

The system is further configured to operate in a fail-safe manner. During a retraction sequence, the control system monitors for fault conditions including, but not limited to, mechanical obstruction, actuator malfunction, sensor inconsistency, loss of power, or misalignment of components. Upon detection of a fault condition, the control system inhibits or terminates the retraction sequence.

In a fail-safe condition, the landing gear remains in or returns to the deployed configuration. This ensures that the aerial vehicle retains the ability to land safely and prevents entry into a configuration that could compromise stability or structural integrity. In some embodiments, the system may also disable or inhibit interaction with external structures, such as docking or transport interfaces, when the landing gear is not properly stowed.

In some embodiments, the aerial vehicle is configured to interact with an external platform for transport, storage, or charging. The reduced spatial envelope achieved by the stowed configuration facilitates placement of the aerial vehicle on such platforms, including platforms mounted to ground vehicles or stationary installations. Alignment features, sensors, or guidance systems may be used to position the aerial vehicle relative to the platform; however, the retractable landing gear system described herein does not require any particular platform configuration and may be used independently of any specific docking system.

The system may further include a shock absorption mechanism associated with the landing gear. In some embodiments, this shock absorption mechanism is configured to serve multiple functions, including absorbing landing loads and providing impact protection to structures associated with a passenger or payload. By sharing shock absorption functionality between landing and payload support systems, overall system weight and complexity may be reduced.

The sequence of operation for transitioning from the deployed configuration to the stowed configuration may include detecting that no passenger or payload is present, verifying that all safety criteria are satisfied, disengaging any mechanical interlocks, and actuating the landing gear and associated structures into their stowed positions. A reverse sequence may be used to deploy the landing gear prior to landing or mission operations.

Although specific embodiments have been described, it will be appreciated that various modifications and alternative configurations may be implemented without departing from the scope of the invention. The arrangement of components, types of sensors, forms of actuation, and specific geometries of the landing gear and secondary structures may vary depending on the application. Accordingly, the scope of the invention is defined by the appended claims rather than by the specific embodiments described herein.

What is claimed is:

1. An aerial vehicle comprising:
a primary flight assembly;
a set of landing gear movable between a deployed configuration and a stowed configuration;
at least one secondary structure positioned below the primary flight assembly, the secondary structure including at least one of a passenger seat, a control interface, or a payload support structure; and
a coupling between the landing gear and the secondary structure, wherein the landing gear and the secondary structure are configured to move in a coordinated manner during transition between the deployed configuration and the stowed configuration such that, in the stowed configuration, both the landing gear and the secondary structure occupy at least a portion of a common internal region of the aerial vehicle to reduce an overall spatial envelope of the aerial vehicle.

2. An aerial vehicle comprising:
a set of landing gear movable between a deployed configuration and a stowed configuration;
at least one sensor configured to detect a condition associated with at least one of passenger presence or payload presence; and
a control system configured to:
permit transition of the landing gear to the stowed configuration only when the detected condition satisfies a predefined safety criterion; and
inhibit or terminate the transition to the stowed configuration upon detection of a fault condition such that the landing gear remains in or returns to the deployed configuration.

3. The aerial vehicle of claim 1, wherein the landing gear is configured to retract into a region located below the primary flight assembly and above a lower boundary of the aerial vehicle.

4. The aerial vehicle of claim 1, wherein the secondary structure is configured to fold or collapse into a compact configuration concurrently with retraction of the landing gear.

5. The aerial vehicle of claim 1, wherein the coupling between the landing gear and the secondary structure includes a shared actuator or linked mechanical members.

6. The aerial vehicle of claim 2, wherein the at least one sensor includes at least one of a seat sensor, a load sensor, a restraint sensor, or a payload retention sensor.

7. The aerial vehicle of claim 2, wherein the control system requires confirmation from a plurality of sensors before permitting transition to the stowed configuration.

8. The aerial vehicle of claim 2, wherein the fault condition includes at least one of mechanical obstruction, actuator failure, sensor inconsistency, or power interruption.

9. The aerial vehicle of claim 2, wherein the control system is further configured to disable engagement with an external platform when the landing gear is not in the stowed configuration.

10. The aerial vehicle of claim 1, wherein the coordinated movement reduces a maximum height of the aerial vehicle in the stowed configuration.
